(19) United States
(12) Patent Application Publication
(10) Pub. No.: US 2004/0133632 A1
(43) Pub. Date: Jul. 8, 2004

(54) Method and apparatus for supporting multiple digital-rights management systems

(76) Inventors: Thomas Messerges, Schaumburg, IL (US); Ronald Buskey, Loves Park, IL (US); Ezzat A. Dabbish, Cary, IL (US)

Correspondence Address: MOTOROLA, INC., 1303 EAST ALGONQUIN ROAD, IL01/3RD, SCHAUMBURG, IL, 60196

(21) Appl. No.: 10/338,375

(22) Filed: Jan. 8, 2003

(51) Int. Cl. G06F 15/177; G06F 15/16

(52) U.S. Cl. 709/203; 709/221

(57) ABSTRACT

Logic circuitry (301) determines that digital content (317) needs to be accessed or obtained and then determines a DRM core (307), or protocol necessary to obtain/access the digital content. If the DRM core (307) is not resident in memory, the core is downloaded from a DRM solution center (103). An application (305) will utilize the DRM core to access or obtain the digital content.

### FIELD OF THE INVENTION

The present invention relates generally to digital-rights management and in particular, to a method and apparatus for supporting multiple digital-rights management systems.

### BACKGROUND OF THE INVENTION

The ease at which valuable digital content (e.g., music, games, video, pictures, and books) can be copied and shared is worrisome to content owners. It is critical that content owners are fairly reimbursed. Because of this, it is a requirement that content distributors implement secure measures that help prevent piracy. Digital-Rights Management (DRM) is a phrase used to describe such protection of rights and the management of rules related to accessing and processing digital content. Content owners hope to protect their valuable digital content using a DRM system that is implemented by secure, tamper-resistant electronic devices.

Next generation cellular phones are planned to include the ability to handle multimedia content, such as digital music, electronic books, electronic games, and digital movies. Cellular operators and content owners are requiring that these new phones be equipped with DRM solutions. Unfortunately, there exists no single DRM solution accepted by all content providers. As a result cellular telephones must be designed to easily accommodate multiple DRM solutions.

Prior-art methods for implementing multiple DRM solutions require either a separate application, or a separate stand-alone DRM solution for each DRM protocol supported. For example, a cellular telephone capable of playing standard MPEG Audio Layer 3 (MP3) files currently requires a separate MP3 player (application) for each DRM protocol supported by the phone, or separate stand-alone DRM applications. While this may be easy to accomplish in principle, in reality implementing multiple applications to render digital files takes up valuable system resources, especially in memory-constrained devices. Therefore a need exists for a method and apparatus for supporting multiple DRM systems, in a memory-constrained device, yet makes efficient use of limited system resources.

### BRIEF DESCRIPTION OF THE DRAWINGS

FIG. 1 is a block diagram of a digital-rights management system in accordance with the preferred embodiment of the present invention.

FIG. 2 is a flow chart showing operation, of the digital-rights management system of FIG. 1 in accordance with the preferred embodiment of the present invention.

FIG. 3 is a block diagram of the user equipment of FIG. 1 in accordance with the preferred embodiment of the present invention.

FIG. 4 is a flow chart showing operation of the user equipment of FIG. 3 in accordance with the preferred embodiment of the present invention.

### DETAILED DESCRIPTION OF THE DRAWINGS

To address the need for multiple digital-rights management solutions within a single memory-constrained device, a method and apparatus for performing digital-rights management is disclosed herein. In accordance with the preferred embodiment of the present invention the memory-constrained device comprises an application block, a system services block, and an interchangeable DRM core. The application block provides top-level application software that processes and renders digital content. This software is trusted to properly handle digital content and to not compromise the DRM usage rules. Example software in the applications block includes music/video players, book readers, picture viewers, and electronic games.

The system services block provides low-level functions that are commonly needed by any DRM core block. This software must also be trusted to properly handle digital content and DRM support functions. Examples of these functions include file services, security services, network services, and content handling services (e.g., MPEG decoding, display drivers, etc.).

Finally, the DRM core block provides common DRM functions that are implemented for a specific DRM protocol, vendor, or standard. Different DRM core blocks interface to the application and system services blocks using common Application Programming Interfaces (APIs).

Even though the core DRM software will be different for each DRM solution, standard APIs make it unnecessary to redesign the application block and system services software. Additionally, the above-described solution requires only a single DRM solution to be resident in memory. This greatly reduces the amount of system resources required over prior-art solutions.

The present invention encompasses a method for supporting multiple DRM systems. The method comprises the steps of determining a DRM protocol necessary to obtain or access digital content and determining if the DRM protocol is resident in memory. Based on whether or not the DRM protocol is resident in memory, the DRM protocol is downloaded into the memory.

The present invention additionally encompasses an apparatus comprising a memory and logic circuitry. In the preferred embodiment of the present invention the logic circuitry determines a DRM protocol necessary to obtain or access (e.g., display, play, install, execute, . . . etc.) digital content and based on whether or not the DRM protocol is resident in the memory, the logic circuitry downloads the DRM protocol into the memory.

Finally, the present invention encompasses an apparatus comprising an application requiring execution of a DRM protocol and an interchangeable DRM core comprising the DRM protocol.

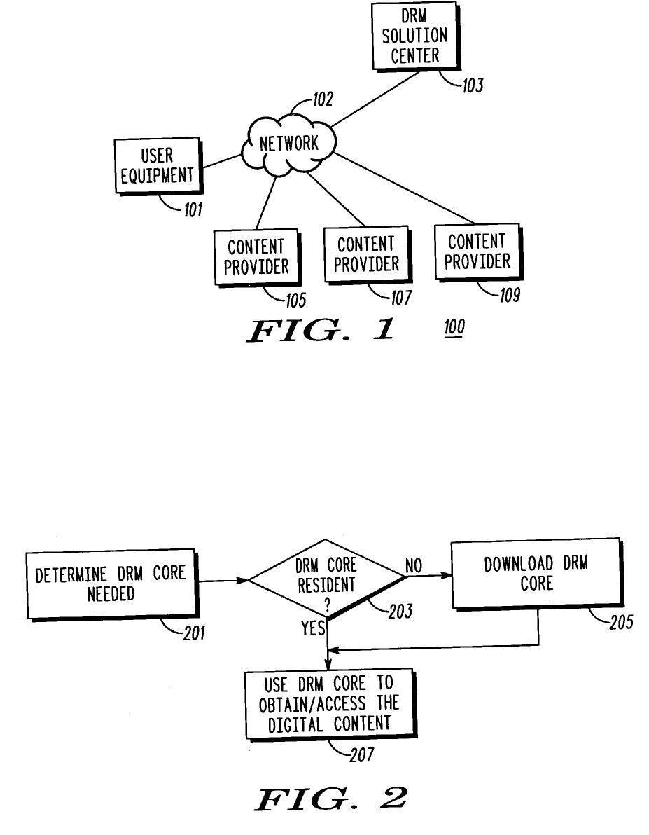

Turning now to the drawings wherein like numerals designate like components, FIG. 1 is a block diagram of digital-rights management system 100 in accordance with the preferred embodiment of the present invention. As shown, DRM system 100 comprises user equipment 101, DRM solution center 103, a plurality of content providers 105-109, and network 102.

In the preferred embodiment of the present invention user equipment 101 comprises a cellular telephone capable of running an application that renders digital content. For example, user equipment 101 may comprise a Motorola A830 cellular telephone equipped to play an MPEG Video Layer 4 file with a standard MPEG video codec. In alternate embodiments user equipment may comprise other devices such as, but not limited to personal digital assistants, portable players, hand held computers, . . . , etc. For example, user equipment 101 may be a personal digital assistant equipped with an application to “play” an MPEG Audio Layer 3 (MP3) file with an application such as a standard MP3 player. Other possible embodiments for digital content include, but are not limited to music, games, video, pictures, books, maps, software, etc.

DRM solution center 103 is preferably a database that houses known DRM protocols. DRM solution center 103 provides a DRM core to user equipment 101 when user equipment 101 requests an appropriate DRM solution from center 103. The DRM core specifically comprises those instructions necessary to execute a particular DRM protocol.

Content providers 105-109 are preferably databases that provide digital content to user equipment 101 after executing appropriate DRM protocols. For example, content provider 105 may provide MP3 files to user equipment 101 utilizing a DRM protocol as is being developed in MPEG-21 (ISO/IEC TR 21000-1:2001(E) “Part 1: Vision, Technologies and Strategy”, available from http://www.iso.ch/iso/en/ittf/) while content provider 107 may provide digital video to user equipment 101 utilizing a second DRM protocol as described in the OMA standard (Digital Rights Management Version 1.0, Version 05 Sep. 2002, Open Mobile Alliance OMA-Download-DRM-v1_{—}0-20020905-a). The content provider may also play the role of the DRM solution center 103. In this case, the user equipment 101 can obtain both the content and the DRM protocol needed to obtain or access content from the same entity.

In accordance with the preferred embodiment of the present invention all communication between devices takes place over network 102. Network 102 may take various forms such as but not limited to a cellular network, a local-area network, a wide-area network, a hard-wired connection, . . . , etc. As described above, in the preferred embodiment of the present invention user equipment 101 comprises a standard cellular telephone, with network 102 comprising a cellular network such as a Code-Division, Multiple-Access communication system.

Regardless of the form that user equipment 101, network 102, DRM solution center 103, and content providers 105-109 take, it is contemplated that these elements within DRM system 100 are configured in well known manners with processors, memories, instruction sets, and the like, which function in any suitable manner to perform the function set forth herein.

During operation, user of equipment 101 may wish to download digital content from a content provider. As discussed above, there exists no single DRM solution accepted by all content providers. As a result cellular telephones must be designed to easily accommodate multiple DRM solutions. In order to address this need, in the preferred embodiment of the present invention user equipment will access the content provider to determine which DRM solution the content provider requires. After determining the solution, user equipment 101 will determine if the DRM core, supporting this solution, is already resident in memory and, if not, will access DRM solution center 103 to download the particular solution. The content provider is then accessed with the appropriate DRM solution.

FIG. 2 is a flow chart showing operation of system 100 in accordance with the preferred embodiment of the present invention. The following logic flow assumes that user equipment 101 is attempting to download digital content from a content provider or to access DRM-protected digital content already resident on user equipment 101. The logic flow begins at step 201 where user equipment 101 determines a DRM core (i.e., a group of functions that are implemented for a specific DRM protocol, vendor, or standard) needed to download/access the digital content. In the preferred embodiment of the present invention user equipment accesses the content provider and is provided with a specific unique electronic terminal identifier that identifies the particular DRM protocol utilized by the digital content.

Once the DRM protocol is determined the logic flow continues to step 203 where user equipment 101 determines if the DRM core (protocol) is already resident in memory. If, at step 203 it is determined that the DRM core (protocol) is already resident in memory, the logic flow continues to step 207 where user equipment 101 uses the DRM core (e.g., it executes a vendor or standards-specific protocol) to obtain/access the digital content. However, if at step 203 it is determined that the DRM core (protocol) is not resident in memory, user equipment 101 accesses DRM solution center 103 and obtains the appropriate DRM core. In order to reduce memory, the new DRM core may replace the resident DRM core. Regardless of whether the resident DRM core is replaced, the logic flow continues to step 207 where user equipment 101 uses the appropriate DRM core to download/access the digital content.

Because only a single DRM core needs to be resident within user equipment 101, the above described solution allows for multiple DRM cores to be executed by user equipment 101 without the system resources needed for prior-art equipment. More particularly, user equipment 101 can now execute any number of DRM protocols without having multiple applications or multiple DRM solutions resident in memory.

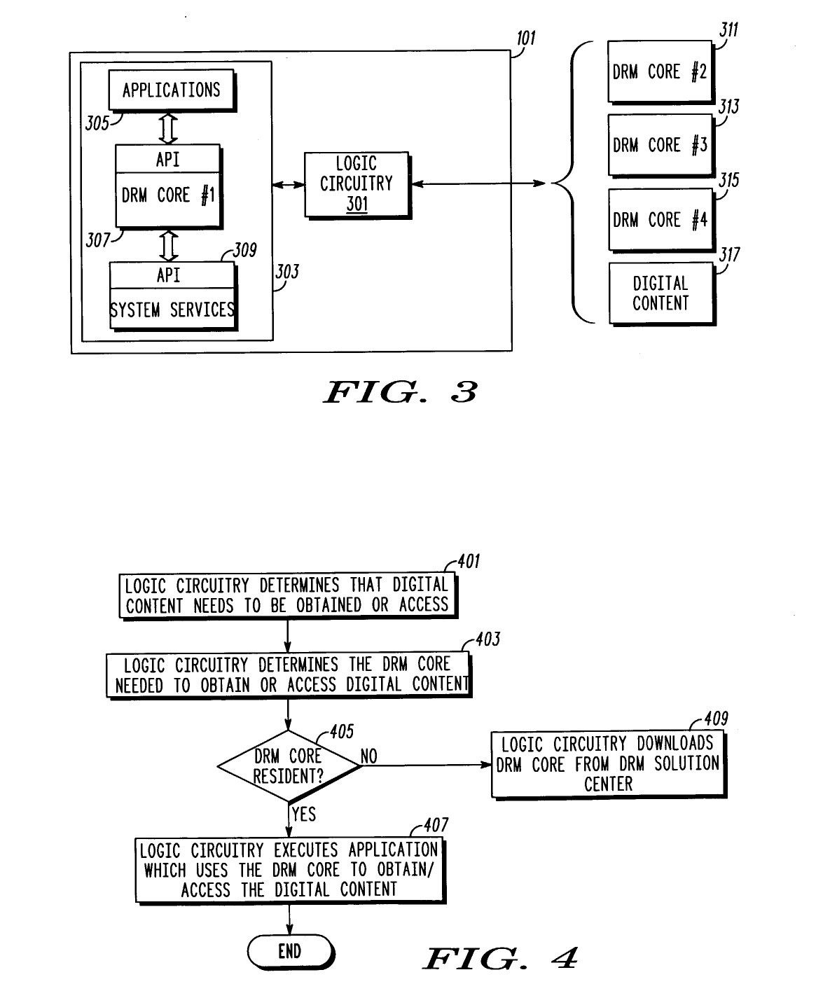

FIG. 3 is a block diagram of the user equipment 101 of FIG. 1 in accordance with the preferred embodiment of the present invention. As shown, user equipment 101 comprises storage 303 for storing applications 305, digital content 317, DRM core 307, and system services 309. Storage 303 may comprise any number of storage means, including, but not limited to hard disk storage, random-access memory (RAM), and smart card storage (e.g., Wireless Identity Module used in cellular telephones), or a removable memory device such as a Multi-Media Card (MMC) or memory stick™ available from Sony Inc. User equipment 101 additionally includes logic circuitry 301, which in the preferred embodiment of the present invention comprises a microprocessor controller such as but not limited to a Motorola MC68328 DragonBall integrated microprocessor or a TI OMAP1510 processor.

In general, DRM is enforced using the concept of a license file and a protected content file, or protected container of files. The license file will contain the usage rules, which are signed by a trusted authority (perhaps the content provider or owner) and the protected content file will contain the protected digital content, which can be rendered only by devices possessing the corresponding license file. When content is rendered, a trusted application will use a particular DRM core to authenticate licenses, parse and enforce rules, and parse and decrypt content. The DRM core will use system services 309 to help perform common functions, such as file-system management or cryptographic algorithms. The use of a standard API between the DRM core and the application and system services blocks enables the DRM core blocks to be interchangeable.

As a first step towards rendering a DRM-protected item, a user will execute application 305. A list of digital items that can be rendered is displayed and the user will select one of these items. Upon selection, the trusted rendering application will identify the DRM core required and install it. Then, the trusted rendering application will use the DRM core's standardized API to initiate the processing of a license and digital content. The first task of the DRM core will be to authenticate the license. Next, the rules in the license will be parsed and enforced. The DRM core can use the system services 309 to check the integrity of the rules (e.g., verify a digital signature). Also, since a particular piece of content might only allow a one-time-play, the DRM core makes a record of this play and securely stores this record into memory 303.

System services 309 can be used to maintain a database that can securely store state information, such as the number times a piece of content was played. To use this database, the DRM core accesses the system services' standardized API to invoke a function that updates a file that is kept in an access-controlled file system. After the file is updated, the trusted rendering application can use the DRM core to access the content. The DRM core may again require the use of system services 309 to decrypt the content (e.g., using the AES cryptographic algorithm) and ensure its integrity (e.g., using a cryptographic hash such as SHA-1).

Although in the preferred embodiment of the present invention core blocks are downloaded from DRM solution center 103, in alternate embodiments of the present invention there are a number of differing ways that DRM core blocks can be managed. For example, a specific DRM core block can be preinstalled at the factory depending on the customers needs. Alternatively, a DRM core block can be installed at an operator's site during a point-of-sale transaction. Thus, in an alternate embodiment of the present invention, content providers may also easily provide the particular DRM protocol to the device.

FIG. 4 is a flow chart showing operation of user equipment 101 of FIG. 3 in accordance with the preferred embodiment of the present invention. The logic flow begins at step 401 where logic circuitry 301 determines that digital content needs to be accessed or obtained. At step 403, logic circuitry determines a DRM core that supports the DRM protocol, necessary to obtain/access the digital content. In particular, if digital content is being obtained, logic circuitry 301 accesses a content provider to determine a particular DRM core necessary to obtain the content, however, if digital content (already resident in memory 303) is being accessed, logic circuitry 301 may instead access the DRM-protected digital content to determine a DRM core necessary to access the content. Regardless of how a DRM core is determined, at step 405 logic circuitry 301 determines if the DRM core is currently resident in memory 303, and if so the logic flow continues to step 407. If, however, it is determined that the DRM core is not currently resident in memory 303, the logic flow continues to step 409.

At step 409, the DRM core, which supports the needed DRM protocol, is downloaded from DRM solution center 103 and the logic flow returns to step 407. At step 407, logic circuitry 301 obtains/accesses the digital content. Particularly, if digital content was being accessed, logic circuitry 301 executes application 305. As discussed above, application 305 will utilize the DRM core by placing calls through the API to perform tasks such as returning a list of available content of the type usable by the application 305, opening and providing paths for the information stored in the files to be parsed and processed by the application, or decrypting and returning digital data to the application for rendering. If, however, digital content is being downloaded from a content provider, then logic circuitry 301 accesses DRM core 307 to determine the steps (i.e., protocol) necessary to download the content. For example, the DRM core may handle specific protocols for making payments or performing authentication.

It should be noted that the DRM core, or protocol is not part of the application. Thus, only a single application needs to be resident in memory, with the application accessing the interchangeable DRM core. As discussed above, because only a single DRM core needs to be resident within user equipment 101, the above described solution allows for multiple DRM cores to be executed by user equipment 101 without the system resources needed for prior-art equipment. More particularly, user equipment 101 can now execute any number of DRM protocols without having multiple applications or multiple DRM solutions resident in memory. A single application can access the content using the DRM core it needs. For example, unlike prior art solutions, the user interface for a music player can be the same software regardless of the underlying DRM core that is providing the DRM services and executing the DRM protocols.

While the invention has been particularly shown and described with reference to a particular embodiment, it will be understood by those skilled in the art that various changes in form and details may be made therein without departing from the spirit and scope of the invention. It is intended that such changes come within the scope of the following claims.

1. A method for supporting multiple digital-rights management (DRM) systems, the method comprising the steps of:
determining a DRM protocol necessary to obtain or access digital content;
determining if the DRM protocol is resident in a memory; and
based on whether or not the DRM protocol is resident in memory, downloading the DRM protocol into the memory.

2. The method of claim 1 further comprising the step of:
utilizing the DRM protocol to access the digital content, wherein the digital content is resident within the memory.

3. The method of claim 1 further comprising the step of:
utilizing the DRM protocol to obtain the digital content.

4. The method of claim 1 further comprising the step of:
deleting an existing DRM protocol from memory and replacing the existing DRM protocol with the downloaded DRM protocol.

5. The method of claim 1 wherein the step of determining the DRM protocol necessary comprises the step of accessing a content provider to determine the DRM protocol necessary.

6. The method of claim 1 wherein the step of determining the DRM protocol necessary comprises the step of accessing the digital content to determine the DRM protocol necessary.

7. The method of claim 1 wherein the step of determining the DRM protocol necessary to obtain/access digital content comprises the step of determining, via a cellular telephone, the DRM protocol necessary to obtain/access digital content.

8. An apparatus comprising:
a memory; and
logic circuitry determining a DRM protocol necessary to obtain/access digital content and based on whether or not the DRM protocol is resident in the memory, downloading the DRM protocol into the memory

9. The apparatus of claim 8 wherein the logic unit uses the DRM protocol to access the digital content already resident in memory.

10. The apparatus of claim 8 wherein the logic unit uses the DRM protocol to obtain the digital content.

11. The apparatus of claim 8 wherein the logic unit deletes an existing DRM protocol from the memory and replaces the DRM protocol with the downloaded DRM protocol.

12. The apparatus of claim 8 wherein the logic unit accesses a content provider to determine the DRM protocol.

13. The apparatus of claim 8 wherein the logic unit accesses digital content to determine the DRM protocol.

14. The apparatus of claim 8 wherein the memory and the logic circuitry is housed within an apparatus taken from the group consisting of a cellular telephone, a personal digital assistant, a portable player, and a hand held computer.

15. An apparatus comprising:
an application requiring execution of a DRM protocol; and
an interchangeable DRM core comprising the DRM protocol.

16. The apparatus of claim 15 wherein the application and the interchangeable DRM core are housed within an apparatus taken from the group consisting of a cellular telephone, a personal digital assistant, a portable player, and a hand held computer.
